(19) United States
(12) Patent Application Publication
(10) Pub. No.: US 2026/0277226 A1
(43) Pub. Date: Sep. 17, 2026

(54) MOVABLE PLATFORM CONTROL METHOD AND APPARATUS, MOVABLE PLATFORM, AND MEDIUM

(71) Applicant: SZ DJI TECHNOLOGY CO., LTD., Shenzhen (CN)

(72) Inventors: Han WU, Shenzhen (CN); Xingyao YU, Shenzhen (CN); Yansui LIU, Shenzhen (CN)

(21) Appl. No.: 19/667,043

(22) Filed: May 4, 2026

Related U.S. Application Data
(63) Continuation of application No. PCT/CN2023/131522, filed on Nov. 14, 2023.

(51) Int. Cl. G05D 1/628; G05D 1/246; G06V 10/75; G06V 20/17; G05D 109/20; G05D 111/10

(52) U.S. Cl. CPC G05D 1/628; G05D 1/246; G06V 10/751; G06V 20/17; G05D 2109/20; G05D 2111/10; G06V 2201/07

(57) ABSTRACT

A control method includes obtaining trend information of a target object associated with a movement task of a movable platform, and determining a path of the movable platform passing around the target object according to the trend information. The path sequentially includes a first path segment and a second path segment, the first path segment has a first following sensitivity, the second path segment has a second following sensitivity, and the first following sensitivity is greater than the second following sensitivity.

### CROSS-REFERENCE TO RELATED APPLICATION

This application is a continuation of International Application No. PCT/CN2023/131522, filed on Nov. 14, 2023, the entire content of which is incorporated herein by reference.

### TECHNICAL FIELD

The present disclosure relates to the technical field of movable platforms and, particularly, to a movable platform control method and apparatus, a movable platform, and a medium.

### BACKGROUND

With the development of movable platform technologies, movable platforms represented by aircraft are gradually applied in various operation scenarios. Some operation scenarios often have complex environmental factors, which affect efficient execution of flight tasks, such as rugged terrain environments, diverse crop growth conditions, or the like, and dense buildings. Particularly in execution of endurance or return tasks, an existing execution strategy is usually to first fly to a departure height or a return height set by a user. When encountering complex environmental factors, there is no effective response measure, and emergency braking requires manual takeover by the user. Due to frequent interruption of a flight process, flight efficiency is low, energy consumption loss is large, and hands-free operation cannot be truly achieved, resulting in poor user experience.

### SUMMARY

In accordance with the disclosure, there is provided a control method including obtaining trend information of a target object associated with a movement task of a movable platform, and determining a path of the movable platform passing around the target object according to the trend information. The path sequentially includes a first path segment and a second path segment, the first path segment has a first following sensitivity, the second path segment has a second following sensitivity, and the first following sensitivity is greater than the second following sensitivity.

Also in accordance with the disclosure, there is provided a control apparatus including at least one processor, and at least one memory storing computer program code. The at least one memory and the computer program code are configured with the at least one processor such that the control apparatus is configured to obtain trend information of a target object associated with a movement task of a movable platform, and determine a path of the movable platform passing around the target object according to the trend information. The path sequentially includes a first path segment and a second path segment, the first path segment has a first following sensitivity, the second path segment has a second following sensitivity, and the first following sensitivity is greater than the second following sensitivity.

### BRIEF DESCRIPTION OF THE DRAWINGS

FIG. 1 is a flowchart of a control method of an aircraft provided in an embodiment of the present disclosure.

FIG. 2A is a schematic diagram showing obtaining mountain trend information provided in an embodiment of the present disclosure.

FIG. 2B is another schematic diagram showing obtaining mountain trend information provided in an embodiment of the present disclosure.

FIG. 3 is a schematic diagram of a control method of an aircraft provided in an embodiment of the present disclosure.

FIG. 4 is a schematic diagram showing obtaining a first flight position provided in an embodiment of the present disclosure.

FIG. 5 is a schematic diagram of another flight control method of an aircraft provided in an embodiment of the present disclosure.

FIG. 6 is a schematic diagram of another flight control method of an aircraft provided in an embodiment of the present disclosure.

FIG. 7 is a schematic diagram of another flight control method of an aircraft provided in an embodiment of the present disclosure.

FIG. 8 is a schematic diagram of another flight control method of an aircraft provided in an embodiment of the present disclosure.

FIG. 9 is a schematic diagram of another control apparatus of an aircraft provided in an embodiment of the present disclosure.

### DETAILED DESCRIPTION OF THE EMBODIMENTS

The present disclosure is further described in detail below with reference to the accompanying drawings and specific embodiments.

Return flight refers to a process in which an aircraft flies from any position to a takeoff point. For example, the any position includes a position point at which an operation ends.

Endurance refers to a process in which an aircraft flies from the takeoff point to a first operation point. For example, the first operation point is a position point at which a previous operation is interrupted, or a position point at which communication of a previous operation is disconnected.

Following flight refers to a flight in which the aircraft follows trend information of a target object and maintains a certain distance to ground relative to the target object during flight. It should be noted that the following flight in embodiments of the present disclosure is not limited to a specific terrain (such as mountains, hills, terraces, or the like), and is also applicable to objects having trend information such as growing crops (such as trees with different growth conditions, or the like) and buildings (such as high-rise buildings, electric towers, or the like), including both natural landscapes and man-made landscapes. When flying around a specific terrain, it may also be referred to as terrain-following flight. For convenience of description, the terrain is used as an example of the target object below, and other target objects are similar and are not described again. In addition, when the aircraft moves upward and downward around the target object, the distance to ground refers to a vertical height of the aircraft relative to points on an envelope line of the target object. When the aircraft moves leftward and rightward around the target object, the distance to ground refers to a lateral width of the aircraft relative to points on the envelope line of the target object.

In an operation process of an existing aircraft, it is often necessary to execute endurance or return flight tasks to ensure continuity and closure of flight operations. During execution of endurance or return tasks, an existing strategy is usually to first fly to a departure height or a return height set by a user. When encountering complex environmental obstacle factors such as rugged terrain environments, diverse crop growth conditions, dense buildings, or the like, there is no effective response measure, and the aircraft will brake and hover in place, waiting for manual takeover by the user. On one hand, it is difficult for a user performing manual takeover to accurately determine a precise position of the distant aircraft and a global condition of surrounding obstacles, and the operation is dangerous. On the other hand, manual takeover means more decision switching time is consumed, which imposes high requirements on user operation skills and experience. Frequent acceleration and deceleration and sudden heading changes will also aggravate kinetic energy loss. Particularly for a return process, remaining electric energy of the aircraft itself is limited, and it is easy for power to be exhausted before reaching a destination.

For convenience of description, embodiments of the present disclosure use a mountain as the target object, and describe an example of upward and downward terrain-following flight during an endurance process. Other scenarios follow similar principles and all fall within the scope of the present disclosure.

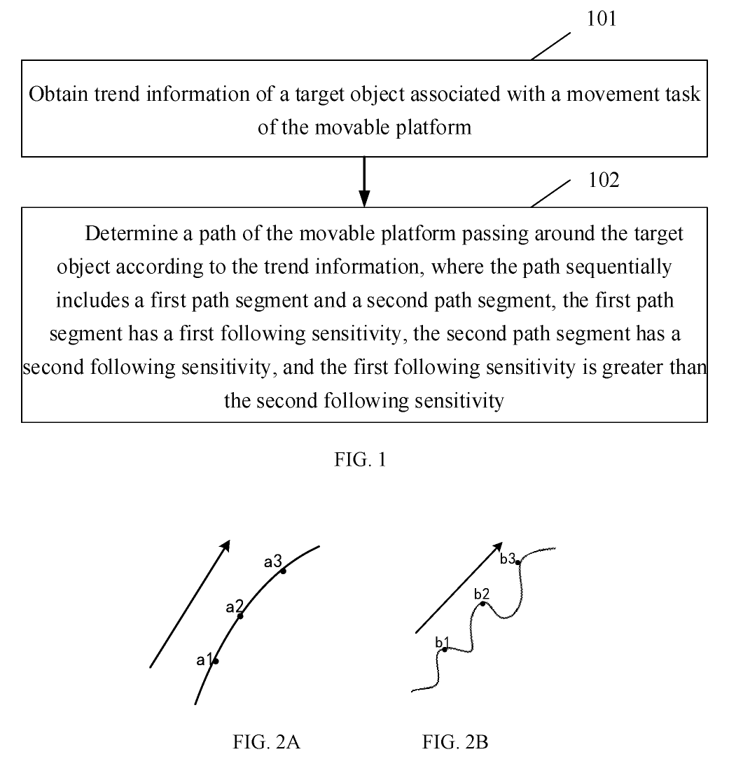

FIG. 1 shows a flowchart of an aircraft control method provided in an embodiment of the present disclosure is shown.

At 101, trend information of a target object is obtained, and the target object is associated with a movement task of the movable platform.

For example, the trend information of the target object may be determined according to detection by onboard sensors of the aircraft, or may be determined according to information received from an external device. For example, the onboard sensors include radar, a visual sensor, an ultrasonic sensor, an infrared sensor, a TOF ranging sensor, GPS, an inertial measurement unit, a barometer, or the like.

For example, the trend information may be determined by at least one of terrain slope, distance to ground, terrain flatness, or variance of distance to ground. In some embodiments, the trend information may be omnidirectional trend information, which not only includes trend information within a range along a nose direction, but also includes trend information within ranges such as both sides of a fuselage, thereby enabling omnidirectional terrain-following flight.

In a relatively ideal case, an envelope line of a mountain should be substantially smooth and continuous. As shown in FIG. 2A, the trend information of the mountain may be determined by measuring heights or height change trends of different points (such as a1, a2, a3) on the envelope line of the mountain. However, in some practical situations, as shown in FIG. 2B, the envelope line of the mountain is excessively uneven, and terrain flatness is less than a set threshold. Representative points (such as peak points b1, b2, b3) may be selected on the terrain to obtain height information, original noise points are removed, and terrain points are fitted, for example, by using a least squares method, to fit the trend information of the mountain. Accordingly, it may indicate that the trend information of the mountain shows a gradually rising trend.

At 102, a path of the movable platform passing around the target object is determined according to the trend information.

The path (e.g., a flight path) sequentially includes a first path segment (e.g., a first flight path segment) and a second path segment (e.g., a second flight path segment). The first path segment has a first following sensitivity (e.g., a first terrain-following sensitivity), and the second route segment has a second following sensitivity (e.g., a second terrain-following sensitivity), where the first following sensitivity is greater than the second following sensitivity (e.g., the first terrain-following sensitivity is greater than the second terrain-following sensitivity).

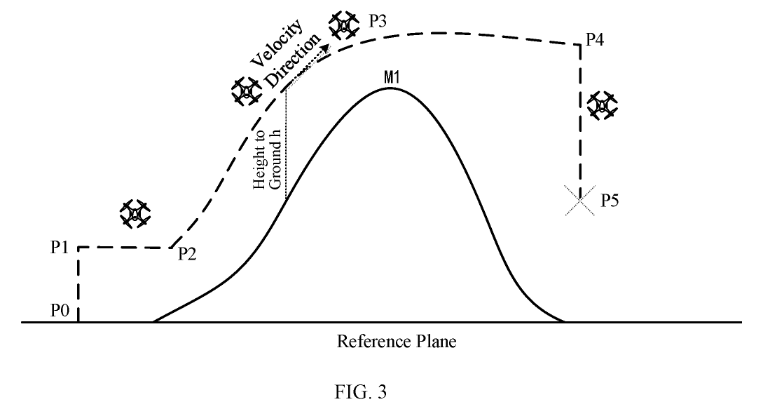

As shown in FIG. 3, for example, a specific execution process is as follows: the aircraft departs from a takeoff point P0 and flies directly to a point P1 corresponding to a departure height. At the point P1, the aircraft enters a level flight attitude. When the aircraft arrives at a point P2 close to the mountain, terrain-following flight is automatically started according to the trend information of the mountain. A first route segment P2P3 having the first terrain-following sensitivity and a second route segment P3P4 having the second terrain-following sensitivity are executed sequentially. Finally, an operation point P5 is reached, and an executed flight path is P0→P1→P2→P3→P4→P5. The first terrain-following sensitivity is greater than the second terrain-following sensitivity. That is, stricter terrain-following is performed in the first route segment, and looser terrain-following is performed in the second route segment. The first route segment is mainly for climbing over obstacles and avoiding collision, and requires passing around obstacles and maintaining a safe distance from the obstacles. Once climbing reaches a highest point of the obstacle, a risk of collision is reduced. Therefore, the second route segment is mainly for reducing power consumption and quickly reaching the destination.

In some embodiments, terrain-following sensitivity is characterized by a following degree and/or a following speed at which the aircraft follows the trend information. That is, the first terrain-following sensitivity is characterized by a following degree and/or a following speed at which the first route segment follows first trend information, and the second terrain-following sensitivity is characterized by a following degree and/or a following speed at which the second route segment follows second trend information, with a value range between 0 and 1. For example, the terrain-following sensitivity may be characterized by a rate of change of ground-relative speed. The rate of change of ground-relative speed refers to a vertical speed change rate in a case of upward and downward terrain-following flight.

In some embodiments, in order to avoid excessive climbing of the aircraft and increased energy consumption, a height to ground range of terrain-following flight may be set to limit a boundary of a flight region of terrain-following flight.

In some embodiments, determining the path of the movable platform passing around the target object according to the trend information includes: determining, according to the trend information of the mountain and/or state information of the aircraft, whether the aircraft reaches a first flight position P3; if the aircraft reaches the first flight position P3, switching from the first route segment P2P3 to the second route segment P3P4, where the first flight position P3 corresponds to a first specific position T1 of the mountain.

In some embodiments, the first specific position M1 is a position at which a projection of the first flight position P3 on a horizontal reference plane intersects an envelope line of the mountain. The first specific position M1 represents a maximum height position of the mountain relative to the same horizontal reference plane. For example, the first specific position may be a highest elevation position of the mountain. It should be noted that the mountain may have one maximum height position or may have multiple maximum height positions. Considering environmental complexity of an actual scenario, the maximum height position of the mountain may be obtained through statistical analysis or fitting analysis of mountain heights in a local region.

In some embodiments, the first specific position M1 represents a position where the mountain changes from an upward trend to a downward trend. For example, the first route segment corresponds to first trend information of the target object, and the second route segment corresponds to second trend information of the target object. The first trend information represents that the target object has an upward trend, and/or the second trend information represents that the target object has a downward trend. The upward trend indicates that the mountain becomes increasingly higher and is likely to cause a collision risk with the aircraft, and potential safety hazards are relatively high. The downward trend indicates that the mountain becomes increasingly lower, indicating that a distance between the mountain and the aircraft becomes increasingly greater, and a corresponding collision risk also becomes increasingly lower.

In some embodiments, at the first flight position P3, relative to the same horizontal reference plane, a flight height of the aircraft is greater than a maximum height of the mountain. It should be noted that, in order to ensure a certain safe distance, it is necessary to ensure that the flight height of the aircraft is greater than the maximum height of the mountain by a certain threshold. For example, the flight height of the aircraft may be determined according to detection by onboard sensors (for example, GPS), or may be determined according to information received from an external device.

In some embodiments, at the first flight position P3, the aircraft switches from an oblique flight attitude to a horizontal flight attitude. For example, the flight attitude of the aircraft may be determined by detection of onboard sensors (for example, an inertial measurement unit), or may be determined by information received from an external device. It should be noted that, in some embodiments, the horizontal flight attitude needs to be maintained for a certain period of time before a current attitude of the aircraft is determined to be the horizontal flight attitude, so as to avoid misjudgment.

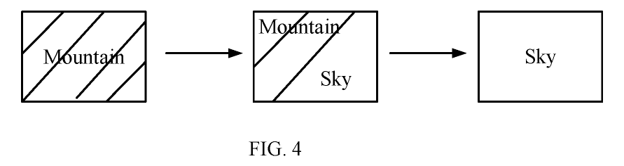

In some embodiments, at the first flight position P3, a pixel proportion of pixels corresponding to the target object in an image captured by the aircraft is less than or equal to a set threshold. For example, a visual sensor or a radar detector of the aircraft sends a detection signal toward a velocity direction of the aircraft, so that the captured image includes, but is not limited to, a visible light image, a point cloud image, or the like. Referring to FIG. 4, during an uphill process of the aircraft, when the aircraft flies to P2, almost the entire captured image is occupied by the mountain image. When the aircraft flies to a position between P2 and P3, part of the mountain image in the captured image is gradually occupied by the sky image. When the aircraft flies to P3, the mountain image in the image is almost entirely occupied by pixels of the sky, and the proportion of mountain pixels is less than or equal to the set threshold. In some cases, the set threshold may be 0. Determining mountain pixels may be implemented by using a semantic recognition manner in the prior art, which is not limited herein. It should be noted that FIG. 4 is merely an exemplary illustration, and in practical applications, the image may further include pixels of other semantic objects.

In some embodiments, at the first flight position P3, at the first movement position, strength of an echo signal received by an onboard sensor of the movable platform is less than a set threshold. During an uphill process of the aircraft, when the aircraft flies to P2, due to reflection of the mountain, the onboard sensor with a detection FOV facing the heading direction receives a relatively strong echo signal. When the aircraft flies to P3, due to almost no reflection from the mountain, the onboard sensor with the detection FOV facing the heading direction receives a relatively weak echo signal. Therefore, whether the aircraft reaches the first flight position P3 may be determined by using the strength of the echo signal received by the onboard sensor.

In some embodiments, the mountain is not an isolated single mountain, but may be a continuous mountain range, and a number of mountains included in the mountain range is not limited. In such a scenario, the route further includes a third route segment, where the third route segment has a third terrain-following sensitivity.

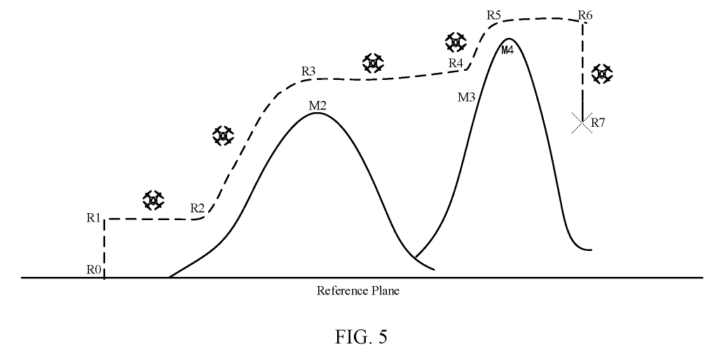

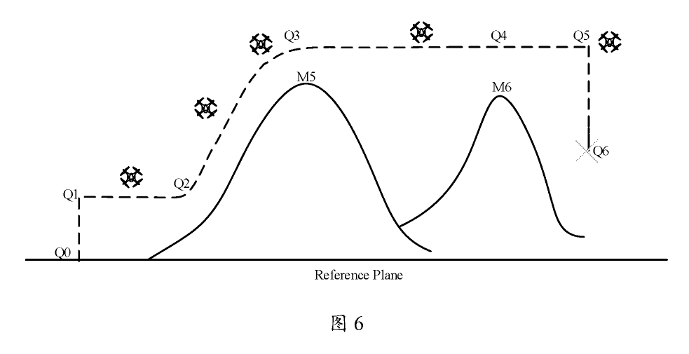

As shown in FIG. 5, the aircraft departs from a takeoff point R0 and flies directly to a point R1 corresponding to a departure height. At the point R1, the aircraft enters a level flight attitude. When flying level to a point R2 close to the mountain, terrain-following flight is automatically started according to the trend information of the mountain. A first route segment R2R3 having the first terrain-following sensitivity and a second route segment R3R4 having the second terrain-following sensitivity are executed sequentially. After reaching a point R4, trend information of another mountain is detected, and terrain-following flight is automatically started according to the trend information of the mountain, and then a third route segment R4R5 having the third terrain-following sensitivity is executed. Finally, an operation point R7 is reached, and an executed route is R0→R1→R2→R3→R4→R5→R6→R7. The first terrain-following sensitivity is greater than the second terrain-following sensitivity, and the third terrain-following sensitivity is greater than the second terrain-following sensitivity.

In some embodiments, determining the route of the aircraft passing around the target object according to the trend information and/or state information of the aircraft further includes: if the aircraft reaches a second flight position R4, switching from the second route segment R3R4 to the third route segment R4R5, where the second flight position R4 corresponds to a second specific position M3 of the target object.

In some embodiments, relative to the same horizontal reference plane, a height of the mountain at position M3 is not less than a height of the mountain at position M2.

In some embodiments, relative to the same horizontal reference plane, a height of the mountain at position M2 is less than a height of the mountain at position M4, where M4 is a position of a maximum elevation of the mountain.

In some embodiments, the mountain exhibits an upward trend at position M3.

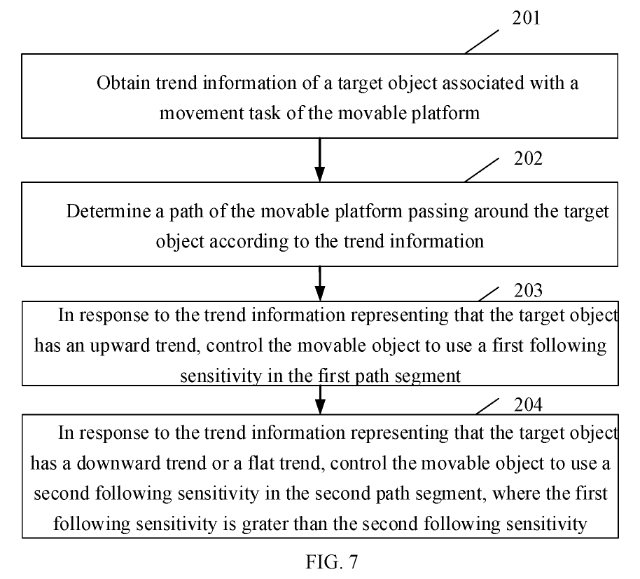

In contrast, as shown in FIG. 6, the aircraft departs from a takeoff point Q0 and flies directly to a point Q1 corresponding to a departure height. At the point Q1, the aircraft enters a level flight attitude. When flying level to a point Q2 close to the mountain, terrain-following flight is automatically started according to the trend information of the mountain. A first route segment Q2Q3 having the first terrain-following sensitivity and a second route segment Q3Q5 having the second terrain-following sensitivity are executed sequentially. Finally, an operation point Q6 is reached, and an executed route is Q0→Q1→Q2→Q3→Q4→Q5→Q6. Although the scenarios in both FIGS. 5 and 6 are scenarios of mountain ranges, in FIG. 6, a height of the mountain at position M6 is less than a height of the mountain at position M5, that is, a maximum elevation of a rear mountain is lower than a maximum elevation of a front mountain. A trend of the rear mountain does not substantially create a collision risk for the flight process of the aircraft. Therefore, the flight may be continuously performed with a relatively low second terrain-following sensitivity until the operation point Q6, without switching to a third terrain-following sensitivity higher than the second terrain-following sensitivity for terrain-following.

In some embodiments, it can be determined that the target object exhibits an upward trend in a vertical direction, according to position information of different position points of the target object detected by the movable platform when sequentially moving to different movement positions.

In some embodiments, it can be determined that the target object exhibits an upward trend in a horizontal direction, according to position information of different position points of the target object detected by the movable platform at multiple time points or within a time period.

In some embodiments, it can be determined that the target object exhibits an upward trend in a vertical direction, according to position information of different position points of the target object determined along a heading direction of the movable platform.

In some embodiments, it can be determined that the target object exhibits an upward trend in a horizontal direction, according to position information of different position points of the target object determined along a heading direction of the movable platform.

In the foregoing embodiments, the route sequentially includes a plurality of route segments. The sequence here includes both continuous sequence and discrete sequence, i.e., other route segments may be interspersed therebetween, as long as, in terms of time sequence, a subsequent route segment is executed after a preceding route segment. Each route segment is composed of a plurality of waypoints.

In the foregoing embodiments, during a flight process of each route segment, the aircraft supports manual stick input intervention by a user, so as to achieve flight control desired by the user.

In the foregoing embodiments, during terrain-following flight, the aircraft also supports superposition of terrain-following movement around multiple obstacles. For example, when an electric tower is present on the mountain, superposition of movement around the mountain and movement around the electric tower is supported.

In the foregoing embodiments, the aircraft further includes an operation tool, and during execution of the flight task, the operation tool is in an idle operation state. For example, the operation tool includes a spraying tool, a spreading tool, a detection tool, or the like. Such arrangement is intended to avoid simultaneous execution of a flight task and an operation task, where a terrain-following flight strategy of the flight task cannot satisfy terrain-following requirements of the operation task, resulting in insufficient operation and low operation efficiency.

The present disclosure further provides a control method of a movable platform, as shown in FIG. 7.

At 201, trend information of a target object is obtained, and the target object is associated with a movement task of the movable platform.

At 202, a path of the movable platform passing around the target object is determined according to the trend information, where the path includes a first path segment and a second path segment.

At 203, in response to the trend information representing that the target object has an upward trend, the movable object is controlled to use a first following sensitivity in the first path segment.

At 204, in response to the trend information representing that the target object has a downward trend or a flat trend, the movable object is controlled to use a second following sensitivity in the second path segment.

The first following sensitivity is greater than the second following sensitivity.

In some embodiments, obtaining the trend information of the target object includes: determining the trend information of the target object according to multiple pieces of specific position information of the target object corresponding to different movement positions sequentially reached by the movable platform.

In some embodiments, obtaining the trend information of the target object includes: determining the trend information of the target object according to multiple pieces of specific position information of the target object determined along a movement direction of the movable platform.

For example, if the multiple pieces of specific position information increase over time relative to the same reference plane, the trend information of the target object is determined to be an upward trend. And/or, if the multiple pieces of specific position information decrease over time relative to the same reference plane, the trend information of the target object is determined to be a downward trend. And/or, if a difference among the multiple pieces of specific position information relative to the same reference plane is less than a preset difference, the trend information of the target object is determined to be a flat trend. If the multiple pieces of specific position information increase along the movement direction relative to the same reference plane, the trend information of the target object is determined to be an upward trend. And/or, if the multiple pieces of specific position information decrease along the movement direction relative to the same reference plane, the trend information of the target object is determined to be a downward trend.

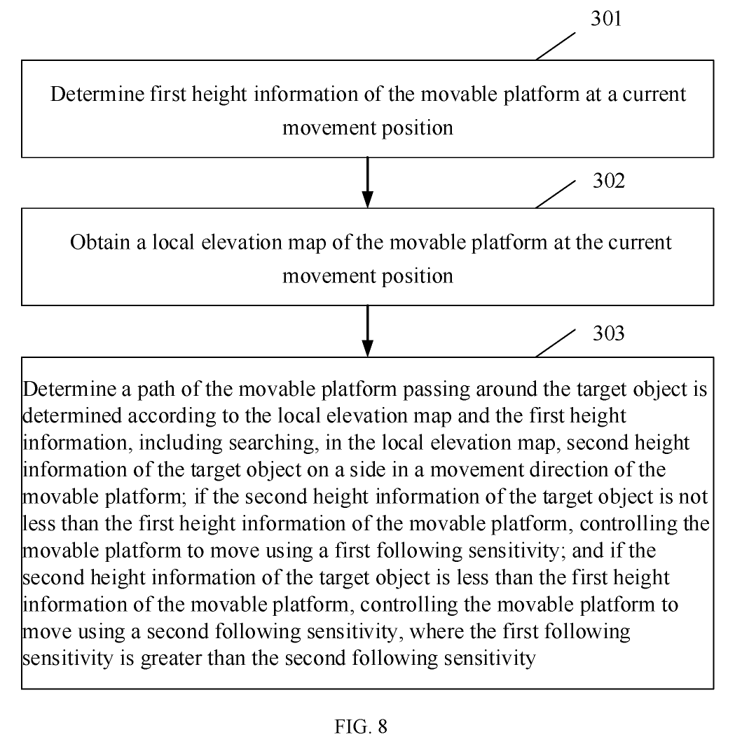

The present disclosure further provides a control method of a movable platform, as shown in FIG. 8.

At 301, first height information of the movable platform at a current movement position is determined.

At 302, a local elevation map of the movable platform at the current movement position is obtained.

At 303, a path of the movable platform passing around the target object is determined according to the local elevation map and the first height information. Determining the path includes:

searching, in the local elevation map, second height information of the target object on a side in a movement direction of the movable platform;

if the second height information of the target object is not less than the first height information of the movable platform, controlling the movable platform to move using a first following sensitivity;

if the second height information of the target object is less than the first height information of the movable platform, controlling the movable platform to move using a second following sensitivity.

The first following sensitivity is greater than the second following sensitivity.

In some embodiments, searching for second height information of the target object along the movement direction of the movable platform in the local elevation map includes: determining a first movement speed of the movable platform at a current movement position, determining a target search range matching the first movement speed, searching, in the local elevation map along the movement direction of the movable platform, for second height information of the obstacle within the target search range.

In some embodiments, the local map has a target search range, and the target search range is positively correlated with an absolute value of the first movement speed. For example, a target search distance is proportional to a flight speed, that is, the higher the flight speed, the larger the target search range, and the lower the flight speed, the smaller the target search range. A forward search distance is longer at a high speed, and a forward search distance is shorter at a low speed. In this embodiment, the search range of the aircraft in a real-time local elevation map is adaptively adjusted according to the flight speed of the aircraft, so that it can be ensured that the aircraft has sufficient time to avoid obstacles when encountering obstacles, thereby further improving flight safety of the aircraft.

In some embodiments, obtaining the local elevation map of the movable platform at the current movement position includes: obtaining a data source of onboard sensors of the movable platform, constructing the local elevation map according to the data source.

For example, the onboard sensor may be a distance detector, a visual sensor, or the like, and may be a data source of a single type of sensor or a fusion of data sources of different types of sensors.

In the foregoing embodiments, the second terrain-following sensitivity may be 0, i.e., no terrain-following response is performed.

In the foregoing embodiments, the movable platform may be an unmanned aerial vehicle, a manned aircraft, an autonomous vehicle, a manned vehicle, a cleaning robot, or the like.

In an unknown mountain environment, it is difficult to obtain global environmental information of the mountain. By using the solution in embodiments of the present disclosure, terrain-following flight can be performed while exploring local trend information, without requiring user takeover, thereby achieving high flight efficiency.

In related art, in order to ensure operation coverage, terrain-following operation usually requires fixed-height terrain-following according to terrain trend information, i.e., maintaining a constant height to ground and using a uniform terrain-following sensitivity. In contrast, in embodiments of the present disclosure, terrain-following flight is mainly intended for detouring to avoid obstacles, and different terrain-following sensitivities may be adaptively used. This not only ensures that the aircraft responds to upward trend information of the terrain with a relatively high terrain-following sensitivity to smoothly climb obliquely and achieve safe collision avoidance, but also enables the aircraft to respond to downward trend information of the terrain with a relatively low terrain-following sensitivity to save energy consumption and avoid unnecessary vertical fluctuations and detours.

In some embodiments, the aircraft does not need to know global information of the mountain, but only needs to obtain a local map of an environment in which the aircraft is located, explore toward an operation point in a detouring obstacle-avoidance manner, and automatically search for a route trajectory until reaching a target point. For example, the aircraft obtains a local elevation map of the environment in real time, and determines local trend information of a mountain corresponding to a current position of the aircraft from the local elevation map. In some other embodiments, the aircraft may perform real-time searching and measurement along a current velocity direction of the aircraft, perform multi-point elevation information measurement at different positions within a certain search radius, and determine local trend information of the mountain corresponding to the current position of the aircraft according to a change trend of multi-point elevation information. The velocity direction of the aircraft is independent of a physical nose direction of the aircraft, and the velocity direction may be any direction among a front, a rear, a left, a right, an upper, and a lower direction of the aircraft. The above methods for determining local trend information are merely exemplary, and other methods capable of determining local trend information also fall within the scope of embodiments of the present disclosure. When it is determined that the mountain corresponding to the current position of the aircraft exhibits an upward trend, a terrain-following strategy with a relatively high first terrain-following sensitivity is executed. When it is determined that the mountain corresponding to the current position of the aircraft exhibits a downward trend, a terrain-following strategy with a relatively low second terrain-following sensitivity is executed.

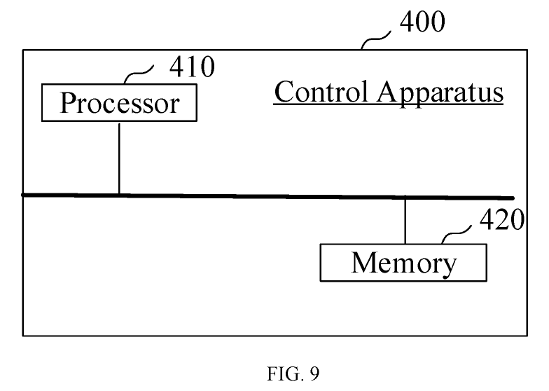

Referring to FIG. 9, the present disclosure further provides a control apparatus 400. The control apparatus 400 includes a processor 410 and a memory 420. The processor 410 and the memory 420 are connected through a bus, for example, an I2C (Inter-integrated Circuit) bus.

Specifically, the processor 410 may be a micro-controller unit (MCU), a central processing unit (CPU), a digital signal processor (DSP), or the like.

Specifically, the memory 420 may be a Flash chip, a read-only memory (ROM), a disk, an optical disk, a USB flash drive, a mobile hard disk, or the like. The memory 420 stores various computer programs for execution by the processor 410.

The processor 410 is configured to run the computer programs stored in the memory and, when executing the computer programs, implement the following operations in the embodiments of the present disclosure.

The control apparatus can include at least one processor 410 and at least one memory 420 storing computer program code. The at least one memory and the computer program code are configured with the at least one processor, such that the control apparatus is at least capable of executing the control method of the movable platform as described above.

The present disclosure further provides a computer-readable storage medium. Instructions are stored on the computer-readable storage medium, and when the instructions are run on a computer, the computer is caused to execute the control method of the movable platform as described above.

For the apparatus embodiments, since they are substantially similar to the method embodiments, the description is relatively simple, and reference may be made to the relevant parts of the method embodiments.

The above descriptions are merely specific embodiments of the present disclosure, but the scope of the present disclosure is not limited thereto. Any person skilled in the art can readily conceive various equivalent modifications or substitutions within the technical scope disclosed in the present disclosure, and these modifications or substitutions shall fall within the scope of the present disclosure. Therefore, the protection scope of the present disclosure shall be subject to the scope of the claims.

What is claimed is:

1. A control method comprising:
obtaining trend information of a target object associated with a movement task of a movable platform; and
determining a path of the movable platform passing around the target object according to the trend information;
wherein the path sequentially includes a first path segment and a second path segment, the first path segment has a first following sensitivity, the second path segment has a second following sensitivity, and the first following sensitivity is greater than the second following sensitivity.

2. The method according to claim 1, wherein determining the path includes:
determining whether the movable platform reaches a movement position corresponding to a specific position of the target object; and
in response to the movable platform reaching the movement position, controlling the movable platform to use the second following sensitivity.

3. The method according to claim 2, wherein the specific position represents at least one of:
a position of a maximum height of the target object relative to a same horizontal reference plane,
a position of a maximum width of the target object relative to the same vertical reference plane, or
a position where the target object changes from an upward trend to a downward trend or a flat trend.

4. The method according to claim 2, wherein the movement position represents at least one of:
a position at which, relative to a same horizontal reference plane, a movement height of the movable platform is greater than a maximum height of the target object,
a position at which, relative to a same vertical reference plane, a movement width of the movable platform is greater than a maximum width of the target object,
a position at which the movable platform switches from an oblique movement attitude to a horizontal movement attitude,
a position at which a pixel proportion of pixels corresponding to the target object in an image captured by the movable platform is less than a set threshold, or
a position at which a strength of an echo signal received by an onboard sensor of the movable platform is less than a set threshold.

5. The method according to claim 2, wherein the specific position is formed by projecting the movement position onto an envelope line of the target object along a preset direction.

6. The method according to claim 5, wherein the preset direction is parallel to a direction of a distance of the movable platform to ground.

7. The method according to claim 1, wherein:
the path sequentially includes the first path segment, the second path segment, and a third path segment; and
the third path segment has a third following sensitivity greater than the second following sensitivity.

8. The method according to claim 7, wherein:
determining the path includes:
determining whether the movable platform reaches a first movement position corresponding to a first specific position of the target object, and in response to the movable platform reaching the first movement position, controlling the movable platform to use the second following sensitivity; and
determining whether the movable platform reaches a second movement position corresponding to a second specific position of the target object, and in response to the movable platform reaching the second movement position, controlling the movable platform to use the third following sensitivity; and
the second specific position and the first specific position satisfy at least one of:
relative to a same horizontal reference plane, a height of the target object at the second specific position is not less than a height of the target object at the first specific position; or
relative to a same vertical reference plane, a width of the target object at the second specific position is not less than a width of the target object at the first specific position.

9. The method according to claim 1, wherein obtaining the trend information includes:
obtaining a local map at a current movement position of the movable platform;
searching, in the local map, for trend information of the target object on a side in a movement direction of the movable platform.

10. The method according to claim 9, wherein the local map has a target search range positively correlated with an absolute value of a current movement speed of the movable platform at the current movement position.

11. The method according to claim 1, wherein:
the first path segment corresponds to first trend information of the target object, and the second path segment corresponds to second trend information of the target object; and
the first trend information represents that the target object has an upward trend, and/or the second trend information represents that the target object has a downward trend or a flat trend.

12. The method according to claim 11, wherein:
the first following sensitivity is characterized by a following amplitude and/or a following speed, at which the first path segment follows the first trend information; and/or
the second following sensitivity is characterized by a following amplitude and/or a following speed, at which the second path segment follows the second trend information.

13. The method according to claim 12, wherein the first following sensitivity and/or the second following sensitivity is characterized by a rate of change of ground-relative speed.

14. The method according to claim 13, wherein the rate of change includes a vertical speed change rate or a horizontal speed change rate.

15. The method according to claim 1, wherein the movement task includes at least one of a return task or an endurance task of the movable platform.

16. The method according to claim 1, wherein the second following sensitivity is greater than or equal to 0.

17. A control apparatus comprising:
at least one processor; and
at least one memory storing computer program code;
wherein the at least one memory and the computer program code are configured with the at least one processor such that the control apparatus is configured to:
obtain trend information of a target object associated with a movement task of a movable platform; and
determine a path of the movable platform passing around the target object according to the trend information;
wherein the path sequentially includes a first path segment and a second path segment, the first path segment has a first following sensitivity, the second path segment has a second following sensitivity, and the first following sensitivity is greater than the second following sensitivity.

18. The apparatus according to claim 17, wherein the control apparatus is further configured to, when obtaining the trend information:
obtain a local map at a current movement position of the movable platform; and
searching, in the local map, for trend information of the target object on a side in a movement direction of the movable platform.

19. The apparatus according to claim 18, wherein the local map has a target query range positively correlated with an absolute value of a current movement speed of the movable platform at the current movement position.

20. The apparatus according to claim 17, wherein:
the first path segment corresponds to first trend information of the target object, and the second path segment corresponds to second trend information of the target object; and
the first trend information represents that the target object has an upward trend, and/or the second trend information represents that the target object has a downward trend or a flat trend.
